(19) United States
(12) Patent Application Publication
(10) Pub. No.: US 2009/0206518 A1
(43) Pub. Date: Aug. 20, 2009

(54) FAST-CHEMICAL-REACTION-PRODUCED GOLF PRODUCT COMPRISING A CAPROLACTAM POLYMER

(75) Inventor: THOMAS J. KENNEDY, III, WILBRAHAM, MA (US)

Correspondence Address: CALLAWAY GOLF C0MPANY, 2180 RUTHERFORD ROAD, CARLSBAD, CA, 92008-7328, US

(73) Assignee: CALLAWAY GOLF COMPANY, CARLSBAD, CA (US)

(21) Appl. No.: 12/434,466

(22) Filed: May 1, 2009

Related U.S. Application Data
(62) Division of application No. 11/548,126, filed on Oct. 10, 2006.
(60) Provisional application No. 60/726,558, filed on Oct. 13, 2005.

(51) Int. Cl. B29C 35/00

(52) U.S. Cl. 264/279.1

(57) ABSTRACT

Disclosed herein are golf products, such as golf balls and golf clubs, and/or components thereof, including the product of a fast-chemical-reaction mixture comprising a caprolactam polyol and an isocyanate. The component is formed by reaction injection molding the reaction mixture.

### CROSS REFERENCES TO RELATED APPLICATIONS

The Present Application is a divisional application of U.S. patent application Ser. No. 11/548,126, filed on Oct. 10, 2006, which claims priority to U.S. Provisional Patent Application No. 60/726,558, filed on Oct. 13, 2005, now abandoned.

### STATEMENT REGARDING FEDERALLY SPONSORED RESEARCH OR DEVELOPMENT

Not Applicable

### BACKGROUND OF THE INVENTION

1. Field of the Invention

The present disclosure generally relates, in various embodiments, to golf equipment or products such as golf balls and clubs including, or comprising, a fast-chemical-reaction-produced component. The component is the product of a reaction mixture comprising, in part, a caprolactam polyol. More particularly, the golf products or components thereof, include the product of a reaction mixture comprising a caprolactam polyol and an isocyanate. For example, the product of the fast-chemical-reaction mixture can be used to form the core, intermediate layer(s) and/or cover layer(s) of a golf ball.

2. Description of the Related Art

Commercial golf balls today consist generally of three types of configurations. The first type is a multi-piece, wound ball in which a vulcanized rubber thread is wound under tension around a solid or semi-solid core, and thereafter enclosed in a single or multi-layer covering of a tough, protective material. A second type of a golf ball is a one-piece ball formed from a solid mass of resilient material which has been cured to develop the necessary degree of hardness to provide utility. A third type of ball is a multi-piece, non-wound ball that includes a liquid, gel or solid core of one or more layers and a cover having one or more layers formed over the core. A wide variety of materials and/or processes have been utilized to formulate the cores, covers, intermediate layers, etc., of these balls, which alter the balls' overall characteristics.

Conventional golf ball covers have been made of ionomer, balata, and slow-reacting, thermoset polyurethane materials. Somewhat recently, golf ball covers made from thermoset polyurethane materials have become very desirable. In this regard, the thermoset polyurethane covers produce similar playability characteristics of balata covered balls with enhanced durability (i.e., increased scuff and cut resistance, etc.) and resilience (i.e., distance). Additionally, the thermoset polyurethane covers produce similar resilience and durability characteristics of ionomer covers with enhanced feel and playability properties.

When slow-reacting, thermoset polyurethane covers are made by conventional methods, such as by casting, a substantial amount of time and energy is required, thus resulting in relatively high cost. In addition, when producing one or more core and/or cover layers from polyurethane, other processing problems occur, including discoloration due to ultraviolet (UV) light, slower reaction times, and insufficient physical properties. Although satisfactory in some respects, a need exists for improved thermoset polyurethane formulations and methods of producing golf products and/or components thereof.

It would be useful to develop a golf product comprising a fast-chemical-reaction-produced component, such as at least one core or cover layer of a golf ball, especially one which comprises a thermoset polyurethane or polyurea material.

### BRIEF SUMMARY OF THE INVENTION

Disclosed herein are various types of golf products or equipment, including golf clubs and golf balls and components thereof, and methods of making the same. The components include the product of a fast-chemical-reaction mixture comprising an isocyanate and a caprolactam polyol. The components are made by reaction injection molding (RIM).

In an exemplary embodiment, a golf ball component, such as a cover, is provided. The golf ball cover includes the product of a fast-chemical-reaction mixture comprising an isocyanate prepolymer and a caprolactam polyol. For example, in certain embodiments, the product of the reaction mixture is a polyamide type material such as nylon 6. Additional golf ball components, such as a core or an intermediate layer produced by these materials and processes are also disclosed herein.

In another embodiment, the reaction mixture further comprises a reactant having one or more hydroxyl groups, a reactant having one or more amine groups, or combinations thereof. In further embodiments, the reactant is a polyether polyol or a polyester polyol.

In another exemplary embodiment, a golf club component is provided. The golf club component includes the product of a fast-chemical-reaction mixture comprising an isocyanate prepolymer and a caprolactam polyol. For example, the golf club component can be a polymeric insert for the face of the golf head of a golf club (i.e., putter, iron, wood, etc.).

A method for making a golf product such as a golf ball component is also disclosed. The method comprises mixing an isocyanate prepolymer and a caprolactam polyol to form a fast-chemical-reaction mixture. The mixture is then molded to form a golf product or a component thereof.

In an additional embodiment of such a method, the reaction mixture further comprises another reactant or agent. The reactant may be a polyol or a reactant containing an active hydrogen atom. The agent maybe additives, fillers, pigments or dyes, antioxidants, U.V. stabilizers, antistatic agents, flow modifiers, catalysts, optical brighteners, release agents, and the like.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 shows a cross-sectional view of a golf ball having a golf ball cover formed according to a fast-chemical-reaction process of the present disclosure.

FIG. 2 shows a cross-sectional view of a golf ball having one or more golf ball components according to the present disclosure.

FIG. 3 shows another cross-sectional view of a golf ball having one or more golf ball components formed according to a reaction injection molding (RIM) process disclosed herein.

FIG. 4 is a process flow diagram which schematically depicts a reaction injection molding process according to the present disclosure.

FIG. 5 shows a mold for reaction injection molding a golf ball cover as set forth herein.

### DETAILED DESCRIPTION OF THE INVENTION

The present disclosure relates to golf products such as golf clubs and golf balls and to components thereof. The golf products and/or components are the product of a fast-chemical-reaction mixture comprising an isocyanate prepolymer and a caprolactam polyol, i.e. the component is formed from the reaction mixture. For example, in a golf ball, such components may include a one-piece golf ball, a cover, an intermediate layer, a layer of a cover, a core, and the like. Golf balls comprising one or more of such components are also within the scope of the disclosure. Generally, the term “golf ball component” will be used herein to mean any part or portion of a golf ball, including the entire golf ball, or any component which may comprise a golf ball. The product of the reaction mixture can also comprise the face of the golf head of a golf club, etc.

In embodiments, the product of the reaction mixture is a polyurethane or a polyurea. The phrase “polyurethane/polyurea” will be used herein to mean a polyurethane, a polyurea, or combinations thereof.

The reaction mixture comprises a caprolactam polyol having the formula C₆H₁₁NO and shown in Formula (I) below:

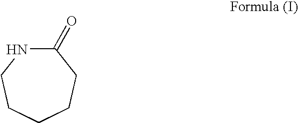

For example, caprolactam can be used for anionic polymerization to form nylon 6. It contains a reactive hydrogen atom attached to the nitrogen atom.

The reaction mixture also comprises an isocyanate prepolymer. The general structure of an isocyanate is R—(NCO)ₙ, where n is at least two, and R is an aromatic or an aliphatic group. Isocyanate groups (—N═C═O) that react with hydroxyl groups form a polyurethane, whereas isocyanate groups that react with an amine group form a polyurea. In an exemplary embodiment, the isocyanate group of the isocyanate prepolymer may react with the nitrogen atom of a caprolactam polyol to form a polyurea. The prepolymer may be a blend of copolymers or a polymer.

The isocyanate prepolymer can comprise a diisocyanate selected from the group including, but not limited to, 4,4′-methylenebis(phenyl isocyanate) (MDI); toluene diisocyanate (TDI); m-xylylene diisocyanate (XDI); hexamethylene diisocyanate (HDI); methylene bis-(4-cyclohexyl diisocyanate) (HDMI); napthalene-1,5 -diisocyanate (NDI); 3,3′-dimethyl-4,4′-biphenyl diisocyanate (TODI); 1,4-diisocyanate benzene (PPDI); phenylene-4,4′-diisocyanate; trimethyl hexamethylene diisocyanate (TMDI); isophorone diisocyanate (IPDI); 1,4-cyclohexyl diisocyanate (CHDI); diphenylether-4,4′-diisocyanate; p,p′-diphenyl diisocyanate; lysine diisocyanate (LDI); 1,3-bis(isocyanate methyl) cyclohexane; polymethylene polyphenyl isocyanate (PMDI); and isomers thereof.

The prepolymer may also comprise an aromatic isocyanate including, but are not limited to, toluene diisocyanate (TDI); diphenyl-methane-diisocyanate (MDI); naphthalene-1,5-diisocyanate (NDI); m- and p-phenylene diisocyanate; toluene-2,4- and -2,6-diisocyanate; diphenylmethane-4,4′-diisocyanate; chlorophenylene-2,4-diisocyanate; naphthalene-1,5-diisocyanate; 3-methyldiphenylmethane-4,4′-diisocyanate; 4,4′-diisocyanate-3,3′-dimethyldiphenylmethane; diphenyl ether diisocyanate; and 3-methyldiphenyhnethane-4,4′-diisocyanate. Generally, aromatic isocyanates exhibit fast reaction times and good physical properties, but tend to have poor light fastness (i.e., discoloration due to UV light).

The prepolymer may also comprise an aliphatic isocyanate including, but not limited to, hexamethylene diisocyanate (HDI); isophorone diisocyanate (IPDI); tetramethylene diisocyanate; octamethylene diisocyanate; decamethylene diisocyanate; dodecamethylene diisocyanate; tetradecamethylene diisocyanate; derivatives of lysine diisocyanate; tetramethylxylylene diisocyanate; trimethylhexane diisocyanate or tetramethylhexane diisocyanate; cycloaliphatic diisocyanates such as 1,4-, 1,3- or 1,2-diisocyanatocyclohexane; 4,4-di(isocyanatocyclohexyl)methane; 1-isocyanato-3,3,5-trimethyl-5-(isocyanatomethyl)cyclohexane(isophorone diisocyanate) or 2,4- or 2,6-diisocyanato-1-methylcyclohexane. Aliphatic isocyanates generally exhibit good light fastness and UV stability, but are slower to react and produce softer polymers than the aromatic isocyanates.

In other exemplary embodiments, the reaction mixture further comprises a reactant having one or more hydroxyl groups, a reactant having one or more amine groups, or combinations thereof. The reactant may be, for example, a polyol or a chain extender. Since the functionality of the reactant or the isocyanate can be varied, a wide variety of branched or cross-linked polymers can be formed. This flexibility in the selection of reactants leads to the wide range of physical properties that allows polyurethanes/polyureas to play an important role in the manufacture of one or more golf ball components.

When the reactant is a polyol, it is typically a polyfunctional alcohol. The polyol can be an alcohol, diol, triol, etc., depending on the number of hydroxyl groups. Also, a blend of polyols and polyamines for reaction with an isocyanate is referred to as a polyol or polyol blend. Although the reaction of an amine with an isocyanate yields a polyurea linkage, the polymer produced from a mixed polyol-polyamine blend may be referred to as a polyurethane. In embodiments, the hydroxyl-functional polyol may have a hydroxyl equivalent weight in the range of 50 to 1500; in further embodiments it has an equivalent weight in the range of 200 to 500. Compounds containing the hydroxyl functional polyol can include polyesters and polyethers. Alternately, the hydroxyl functional polyol is ethylenically saturated. Some saturated polyethers include polymers of propylene oxide or propylene oxide/ethylene oxide; such materials are usually triols or diols with molecular weights between 1000 and 7000. Polyols marketed by the Bayer Corporation, Pittsburgh, Pa., under the trademark DESMOPHEN may also be used or incorporated into the materials disclosed herein. In specific embodiments, the reaction mixture further comprises a polyether polyol or a polyester polyol.

A chain extender lengthens the main chain of polyurethane/polyurea, causing end-to-end attachments. Examples of chain extenders include polyglycols and polyamines. Polyglycols include, but are not limited to, polyethylene glycol; polypropylene glycol (PPG); polybutylene glycol; pentane glycol; hexane glycol; benzene glycol; xylene glycol; 2,3-dimethyl-2,3-butane diol; dipropylene glycol; and their polymers. Suitable amine chain extenders include, but are not limited to, tetramethyl-ethylenediamine; dimethylbenzylamine; diethylbenzylamine; pentamethyldiethylenetriamine; dimethyl cyclohexylamine; tetramethyl-1,3-butanediamine; pentamethyldipropylenetriamine; 1,2-dimethylimidazole; 2-methylimidazole; and bis-(dimethylaminoethyl)ether. In specific embodiments, the reaction mixture further comprises polypropylene glycol (PPG) or polytetramethylene ether glycol (PTMEG).

In addition to these polyols and chain extenders, other reactants containing a reactive hydrogen atom that would react with the isocyanate prepolymer to form the polyurethane/polyurea can be utilized. Such materials include polyamines, polyamides, short oil alkyds, castor oil, epoxy resins with secondary hydroxyl groups, phenolic resins, and hydroxyl functional vinyl resins. Suitable examples of such materials include ANCAMINE 2071, a modified polyamine marketed by Pacific Anchor Chemical Corporation, Los Angeles, Calif.; EPON V-40, a polyamide marketed by Shell Oil Company, Houston, Tex.; AROPLAZ 1133-X-69, a short oil alkyd by Reichhold Inc., Minneapolis, Minn.; EPON resin 828, an epoxyresin marketed by Shell Oil Company; PENTALYN 802A, a phenolic modified polyester resin marketed by Hercules Inc., Wilmington, Del.; and VAGH, a hydroxyl functional vinyl resin marketed by Union Carbide, Danbury, Conn.

In one embodiment, the reaction mixture comprises an isocyanate prepolymer and a caprolactam polyol and the reaction product comprises a polyurea. In another embodiment, the reaction mixture comprises an isocyanate prepolymer, a caprolactam polyol, and a polyether polyol or polyester polyol; the reaction product comprises nylon 6 and a polyurethane.

The thermoset polyurethane selected to be produced from the reaction mixture has a Shore D hardness of 10 to 100. In specific embodiments, it has a Shore D hardness of 30 to 95 or 65 to 90. In particular, the polyurethane, when it has a Shore D hardness greater than 65, also has good impact resistance. The polyurethane also has a flex modulus of 1 to 310 kpsi. In specific embodiments, it has a flex modulus or 5 to 100 kpsi or 30 to 80 kpsi.

Golf balls and golf ball components according to the present disclosure are formed by a fast-chemical-reaction such as reaction injection molding (RIM). RIM is a process by which highly reactive liquids are injected into a closed mold, mixed usually by impingement and/or mechanical mixing in an in-line device such as a “peanut mixer”, and polymerized primarily in the mold to form a coherent, one-piece molded article. The RIM processes of this disclosure involve a rapid reaction between one or more reactants such as a caprolactam polyol, polyether or polyester polyol, or other material with an active hydrogen, and one or more isocyanate-containing constituents, often in the presence of a catalyst. The constituents are stored in separate tanks prior to molding and maybe first mixed in a mix head upstream of a mold and then injected into the mold. The liquid streams are metered in the desired weight to weight ratio and fed into an impingement mix head, with mixing occurring under high pressure, e.g., 1500 to 3000 psi. The liquid streams impinge upon each other in the mixing chamber of the mix head and the mixture is injected into the mold. One of the liquid streams typically contains a catalyst for the reaction. The constituents react rapidly after mixing to gel and form polyurethane polymers. Polyureas, epoxies, and various unsaturated polyesters also can be molded by RIM.

The RIM process used to form golf products and/or components thereof disclosed herein is substantially different from, and advantageous over, the conventional injection and compression molding techniques.

First, during the RIM process of the present disclosure, the chemical reaction, i.e., the mixture of isocyanate from the isocyanate tank and polylactam polyol from the polyol tank, occurs during the molding process. Specifically, the mixing of the reactants occurs in the recirculation mix head and the after mixer, both of which are connected directly to the injection mold. The reactants are simultaneously mixed and injected into the mold, forming the desired component.

Typically, prior art techniques mix the reactants before the molding process. Mixing under either compression or injection molding occurs in a mixer that is not connected to the molding apparatus. Thus, the reactants must first be mixed in a mixer separate from the molding apparatus, then added into the apparatus. Such a process causes the mixed reactants to first solidify, then be melted later in order to properly mold.

Second, the RIM process requires lower temperatures and pressures during molding than injection or compression molding. Under the RIM process, the molding temperature is maintained from about 90 to about 180° F., and usually at about 100-120° F., in order to ensure proper injection viscosity. Compression molding is typically completed at a higher molding temperature of about 320° F. (160° C.). Injection molding is completed at an even higher temperature range of 392-482° F. (200-250° C.). At this elevated temperature, the viscosity of the molten resin usually is in the range of 50,000 to about 1,000,000 centipoise, and is typically around 200,000 centipoise. In an injection molding process, the solidification of the resins occurs after about 10 to about 90 seconds, depending upon the size of the molded product, the temperature and heat transfer conditions, and the hardness of the injection molded material. Molding at a lower temperature is beneficial when, for example, the cover is molded over a very soft core so that the very soft core does not melt or decompose during the molding process. The RIM process, when producing polyurethane materials, usually uses a pressure range of 200 psi or less, and in embodiments, 100 psi or less.

Third, the RIM process creates more favorable durability properties in a golf ball component than does conventional injection or compression molding. For example, a golf ball cover produced according to the present disclosure has a uniform or “seamless” cover in which the properties of the cover material in the region along the parting line are generally the same as the properties of the cover material at other locations on the cover, including at the poles. The improvement in durability is due to the fact that the reaction mixture is distributed uniformly into a closed mold. This uniform distribution of the injected materials reduces or eliminates knit-lines and other molding deficiencies which can be caused by temperature differences and/or reaction differences in the injected materials. The RIM process of the present disclosure results in generally uniform molecular structure, density and stress distribution as compared to conventional injection molding processes, where failure along the parting line or seam of the mold can occur because the interfacial region is intrinsically different from the remainder of the cover layer and, thus, can be weaker or more stressed.

Fourth, the RIM process is relatively faster than the conventional injection and compression molding techniques. In the RIM process, the chemical reaction usually takes place in under 5 minutes, typically in less than two minutes, sometimes in under one minute and, in many cases, in about 30 seconds or less; including about 15 seconds or less. The demolding time of the present application is 5 minutes or less; including 2 minutes or less. The molding process for the conventional methods itself typically takes about 15 minutes. Thus, the overall speed of the RIM process makes it advantageous over the injection and compression molding methods.

The term “demold time” generally refers to the mold release time, which is the time span from the mixing of the components until the earliest possible time at which the part maybe removed from the mold. At that time of removal, the part is said to exhibit sufficient “green strength.” The term “reaction time” generally refers to the setting time or curing time, which is the time span from the beginning of mixing until the time at which the product no longer flows. Further description of the terms setting time and mold release time are provided in the “Polyurethane Handbook,” edited by Gunter Oertel, Second Edition, ISBN 1-56990-157-0, herein incorporated by reference.

A more complete understanding of the processes, products, components and apparatuses disclosed herein can be obtained by reference to the accompanying drawings. These figures are merely schematic representations based on convenience and the ease of demonstrating the present development, and are, therefore, not intended to indicate relative size and dimensions of the golf balls or components thereof.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

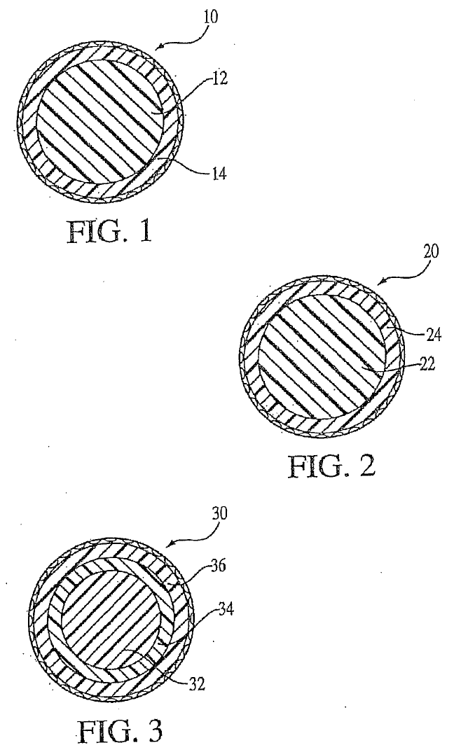

Referring no w to the drawings, FIG. 1 shows a golf ball having a cover comprising RIM polyurethane. The golf ball 10 includes a polybutadiene core 12 and a polyurethane cover 14 formed by RIM. The cover 14 is the product of a reaction mixture comprising, in part, a caprolactam polyol.

FIG. 2 shows a golf ball having a core comprising RIM polyurethane. The golf ball 20 has a RIN polyurethane core 22 and a RIM polyurethane cover 24. One or more of the components are formed from a reaction mixture comprising, in part, a caprolactam polyol. More preferably, the component is the product of a reaction mixture comprising a caprolactam polyol and an isocyanate prepolymer.

FIG. 3 shows a multi-layer golf ball 30 with a solid core 32 containing RIM polyurethane, a mantle cover layer 34 comprising RIN polyurethane, and an outer cover layer 36. The outer cover layer 36 can comprise RIM polyurethane. Alternatively, the outer cover layer 36 can comprise ionomer or another conventional golf ball cover material. Such conventional golf ball cover materials typically contain titanium dioxide utilized to make the cover white in appearance.

The balls shown in FIG. 2 through FIG. 3 may be of a standard, enlarged or reduced size. Further, the core, intermediate and cover components may comprise any number of layers or sub-parts desired.

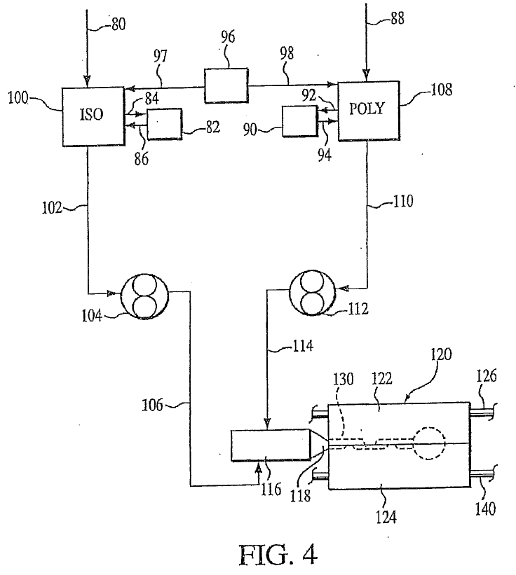

FIG. 4 shows a process flow diagram for forming a RIN cover of polyurethane. Isocyanate from bulk storage is fed through line 80 to an isocyanate tank 100. The isocyanate is heated to the desired temperature, e.g. about 90 to about 150° F., by circulating it through heat exchanger 82 via lines 84 and 86. The isocyanate can be carried in a solvent. Examples of suitable solvents include methyl isobutyl ketone, methyl amyl ketone, butyl acetate and propylene glycol monomethyl ether acetate. The use of methyl isobutyl ketone as the solvent or part-solvent is advantageous because it tends to alleviate any potential moisture problems encountered with the acetate solvents.

Polylactam polyol and other polyols are conveyed from bulk storage to a polyol tank 108 via line 88. The polyol component may also contains additives, such as stabilizers, flow modifiers, catalysts, combustion modifiers, blowing agents, fillers, pigments, optical brighteners, and release agents to modify the physical characteristics of the product. The polyol is heated to the desired temperature, e.g. about 90 to about 150° F., by circulating it through heat exchanger 90 via lines 92 and 94. Dry nitrogen gas is fed from nitrogen tank 96 to isocyanate tank 100 via line 97 and to polyol tank 108 via line 98. Isocyanate is fed from isocyanate tank 100 via line 102 through a metering cylinder or metering pump 104 into recirculation mix head inlet line 106. Polyol is fed from polyol tank 108 via line 110 through a metering cylinder or metering pump 112 into a recirculation mix head inlet line 114. The recirculation mix head 116 receives isocyanate and polyol, mixes them, and provides for them to be fed through nozzle 118 into injection mold 120. The injection mold 120 has a top mold 122 and a bottom mold 124. Mold heating or cooling can be performed through lines 126 in the top mold 122 and lines 140 in the bottom mold 124. The materials are kept under controlled temperature conditions to insure that the desired reaction profile is maintained.

Inside the mix head 116, injector nozzles impinge the isocyanate and polyol at ultra-high velocity to provide excellent mixing. Additional mixing preferably is conducted using an aftermixer 130, which typically is constructed inside the mold between the mix head and the mold cavity. The reaction itself takes place under moisture-proof reactions because caprolactam is water-sensitive. The reaction mixture viscosity should be sufficiently low to ensure that the empty space in the mold is completely filled. The reactant materials generally are preheated to from about 90 to about 150° F. before they are mixed. In most cases it is necessary to preheat the mold to, e.g., from about 100 to about 180° F., to ensure proper injection viscosity.

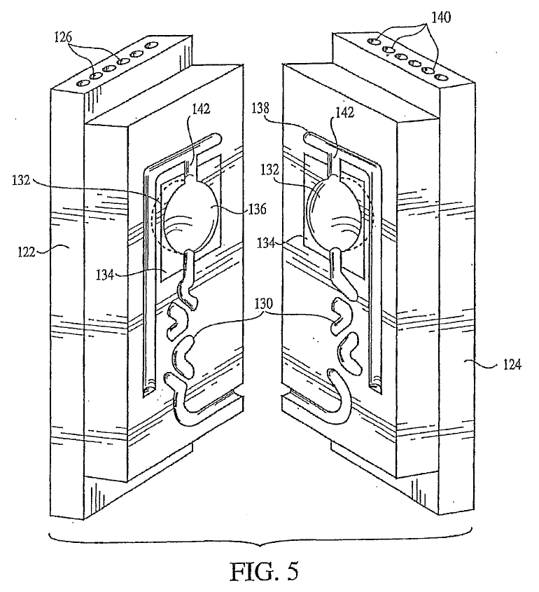

FIG. 5 shows a mold used to make a golf ball cover. The mold includes a golf ball cavity chamber 134 in which a spherical golf ball cavity 132 with a dimpled, inner spherical surface 136 is defined. The aftermixer 130 can be a peanut aftermixer, as is shown in FIG. 5, or in some cases another suitable type, such as a heart, harp or dipper. However, the aftermixer does not have to be incorporated into the mold design. An overflow channel 138 receives overflow material from the golf ball cavity 132 through a shallow vent 142. Heating/cooling passages 126 and 140, which preferably are in a parallel flow arrangement, carry heat transfer fluids such as water, oil, etc. through the top mold 122 and the bottom mold 124.

The mold cavity contains retractable pins and is generally constructed in the same manner as a mold cavity used to injection mold a thermoplastic golf ball cover. However, two differences when RIM is used are that tighter pin tolerances generally are required, and a lower injection pressure is used. Also, because of the lower injection pressure, the molds can be produced from lower strength material such as aluminum.

Non-limiting examples of other suitable RIM systems for use in, or in combination with, the present disclosure are BAYFLEX elastomeric polyurethane RIM systems, BAYDUR GS solid polyurethane RIM systems, PRISM solid polyurethane RIM systems, all from Bayer Corp. (Pittsburgh, Pa.), SPECTRIM reaction moldable polyurethane and polyurea systems from Dow Chemical USA (Midland, Mich.), including SPECTRIM MM 373-A (isocyanate) and 373-B (polyol), and ELASTOLIT SR systems from BASF (Parsippany, N.J.).

The golf ball components of the present disclosure may also be optionally cross-linked by irradiation. Numerous ways are known to induce cross-linking in a polymer by free radical initiation, including peroxide initiation and UV irradiation. Other forms of particle irradiation, including electron beam, also can be used.

Gamma radiation allows golf balls to be irradiated in bulk. Gamma radiation penetrates relatively deep into the material undergoing irradiation, but also increases cross-linking of the inner core. Accordingly, the compression of the core can be adjusted to allow for the increase in hardness stemming from the cross-linking. Electron beam techniques are faster but cannot be used for treating in bulk as the electron beam does not sufficiently penetrate into the material and the product typically needs to be rotated to obtain an even or uniform cross-link density.

The type of irradiation to be used will depend in part upon the underlying layers. For example, certain types of irradiation may degrade windings in a wound golf ball. On the other hand, balls with a solid core would not be subject to the same concerns. However, with any type of core, certain types of irradiation will tend to cross-link and thus harden the core. Depending upon whether this type of effect is sought or is to be avoided, the appropriate type of irradiation can be selected.

The level of radiation employed depends upon the desired end characteristics of the final golf ball component. However, generally a wide range of dosage levels may be used. For example, total dosages of up to about 12.5 or even 15 Mrads maybe employed. Preferably, radiation delivery levels are controlled so that the golf ball component is not heated above about 80° C. (176° C.) while being cross-linked.

Golf ball components may have indicia and/or logos stamped or formed thereon. Such indicia can be applied by printing using a material or a source of energetic particles after the ball core and/or cover have been reaction-injection-molded according to the present invention. Printed indicia can be formed from materials known in the art, such as ink, foil (for use in foil transfer), etc. Indicia printed using a source of energetic particles or radiation can be applied by burning with a laser, burning with heat, directed electrons, or light, phototransformations of, e.g., U.V. ink, impingement by particles, impingement by electromagnetic radiation, etc. Furthermore, the indicia can be applied in the same manner as an in-mold coating, i.e., by applying the indicia to the surface of the mold prior to molding of the cover.

The resulting golf ball component comprises from about 5 to about 100 weight percent of polyurethane based on the weight of the golf ball component. The product of the fast-chemical-reaction mixture may also comprise other agents. When the golf ball component is an outer cover layer, pigments or dyes, accelerators and UV stabilizers can be added. An example of a suitable white pigment is titanium dioxide. Examples of suitable UV light stabilizers are provided in commonly assigned U.S. Pat. No. 5,494,291, herein incorporated by reference. Furthermore, compatible polymeric materials can be added. For example, when the component comprises polyurethane and/or polyurea, such polymeric materials include polyurethane ionomers, polyamides, etc. Fillers can also be incorporated into the golf ball component, including those listed below.

Golf balls comprising a golf ball component according to the present disclosure are also contemplated. If the component is a cover layer, then a wide array of materials may be used for the cores and mantle layer(s) of the golf ball. For instance, the core and mantle or interior layer materials disclosed in U.S. Pat. Nos. 5,833,553; 5,830,087; 5,820,489; and 5,820,488, all of which are hereby incorporated by reference in their entirety, may be employed. If the component is a core or inner layer, then a variety of conventional materials maybe used for one or more cover layers. For instance, the cover layer(s) may employ materials disclosed in U.S. Pat. Nos. 6,309,314; 6,277,921; 6,220,972; 6,150,470; 6,126,559; 6,117,025; 5,902,855; 5,895,105; 5,688,869; 5,591,803; and 5,542,677; hereby fully incorporated by reference.

If the component is a golf ball cover, the golf ball may be a two-piece or multi-layer ball having a wound core, a solid, non-wound core, a liquid core, or a gel core.

One or more intermediate or cover layers can be included having different characteristics. It is particularly advantageous to have an outer cover Shore D hardness of 50 or more, including 65 or more (or at least 100 Shore C). These measurements are made in general accordance with ASTM 2240, except they are made on the ball itself and not on a plaque. The outer layer is from about 0.005 to about 0.20 inches in thickness, including about 0.001 to about 0.100 inches in thickness. Thickness is defined as the average thickness of the non-dimpled cover of the outer cover.

When utilizing an outer cover layer formed from the reaction product of an isocyanate prepolymer and a caprolactam polyol, a conventional core component can be utilized. The core of the golf ball can be formed of a solid, or an encapsulated sphere filled with a gas, a liquid or a gel, or any other substance that will result in a core or an inner ball (core and a at least one inner cover layer, if the ball is a multi-layer ball), having the desired COR, compression and hardness and other physical properties.

The cores of the golf ball typically have a coefficient of restitution of about 0.750 or more, more preferably 0.770 or more, and a PGA compression of about 90 or less, and more preferably 70 or less. Furthermore, in some applications it may be desirable to provide a core with a coefficient of restitution of about 0.780 to about 0.790 or more. The core used in the golf ball is preferably a solid, but any core type known in the art may be used, such as wound, liquid, hollow, metal, and the like. The term “solid cores” as used herein refers not only to one piece cores but also to those cores having a separate solid layer beneath the covers and over the central core. The cores generally have a weight of about 25 to about 40 grams and preferably about 30 to about 40 grams. Larger and heavier cores, or lighter and smaller cores, may also be used when there is no desire to meet U.S.G.A. or R. & A. standards.

When the golf ball of the invention has a solid core, this core can be compression molded from a slug of uncured or lightly cured elastomer composition comprising a high cis content polybutadiene and a metal salt of an α, β, ethylenically unsaturated carboxylic acid such as zinc mono- or diacrylate or methacrylate. To achieve higher coefficients of restitution and/or to increase hardness in the core, the manufacturer may include a small amount of a metal oxide such as zinc oxide. In addition, larger amounts of metal oxide than are needed to achieve the desired coefficient may be included in order to increase the core weight so that the finished ball more closely approaches the U.S.G.A. upper weight limit of 1.620 ounces.

Non-limiting examples of other materials that maybe used in the core composition include, but are not limited to, compatible rubbers or ionomers, and low molecular weight fatty acids such as stearic acid. Free radical initiator catalysts such as peroxides may be admixed with the core composition so that on the application of heat and pressure, a curing or cross-linking reaction takes place. The core may also be formed from any other process for molding golf ball cores known in the art.

A thread wound core may comprise a liquid, solid, gel or multi-piece center. The thread wound core is typically obtained by winding a thread of natural or synthetic rubber, or thermoplastic or thermosetting elastomer such as polyurethane, polyester, polyamide, etc., on a solid, liquid, gel or gas filled center to forma thread rubber layer that is then covered with one or more mantle or cover layers. Additionally, prior to applying the cover layer(s), the thread wound core may be further treated or coated with an adhesive layer, protective layer, or any substance that may improve the integrity of the wound core during application of the cover layers and ultimately in usage as a golf ball.

The core, preferably a solid core, is about 1.2 to about 1.6 inches in diameter, although it may be possible to use cores in the range of about 1.0 to about 2.0 inches. If the ball has a single cover layer, the core size may be up to about 1.660 inches.

The present disclosure includes one or more auxiliary layers disposed on the core, and a preferably immediately adjacent to the outer core surface. For example, for some applications, it may be preferred to deposit a barrier coating that limits transmission of moisture to the core. Such barrier coatings or layers are relatively thin. Generally, such coatings are at least 0.0001 inches, and preferably, at least 0.003 inches in thickness. Furthermore an adhesion promoting layer may be used between the cover layers and/or the core, or the cover and core having a barrier coating disposed thereon. Such adhesion promoting layers are known in the art and maybe used in combination with the features described herein. See for example U.S. Pat. No. 5,820,488, herein incorporated by reference.

The inner cover layer that is molded over the core is preferably about 0.0005 inches to about 0.15 inches in thickness. The inner ball that includes the core and inner cover layer(s), or core for a two piece ball, preferably has a diameter in the range of 1.25 to 1.60 inches. The outer cover layer is about 0.0005 inches to about 0.20 inches thick. Together, the core, the inner cover layer(s) and the outer cover layer (or core and single cover layer) combine to form a ball having a diameter of 1.680 inches or more, the minimum diameter permitted by the rules of the U.S.G.A. and weighing no more than 1.62 ounces. If desired, golf balls of different weights and diameters may also be formed if the rules of the U.S.G.A. are not an issue.

In a particular embodiment of the disclosure, the golf ball has a dimple pattern that provides dimple coverage of 65% or more, preferably 75% or more, and ore preferably about 80 to 85% or more In another embodiment, there are from 300 to less than 500 dimples, preferably from about 340 to about 440 dimples.

Specifically, the arrangement and total number of dimples are not critical and may be properly selected within ranges that are well known. For example, the dimple arrangement may be an octahedral, dodecahedral or icosahedral arrangement. The total number of dimples is generally from about 250 to about 600, and especially from about 300 to about 500.

In a further embodiment, the golf ball typically is coated with a durable, abrasion-resistant, relatively non-yellowing finish coat or coats if necessary. The finish coat or coats may have some optical brightener and/or pigment added to improve the brightness of the finished golf ball. In one embodiment, from 0.001 to about 10% optical brightener may be added to one or more of the finish coatings. If desired, optical brightener may also be added to the cover materials. One type of preferred finish coatings are solvent based urethane coatings known in the art. It is also contemplated to provide a transparent outer coating or layer on the final finished golf ball.

Golf balls also typically include logos and other markings printed onto the dimpled spherical surface of the ball. Paint, typically clear paint, is applied for the purposes of protecting the cover and improving the outer appearance before the ball is completed as a commercial product.

If the core in the component is formed from the caprolactam polyol, the same processing conditions are used as are described above with respect to covers. One difference is, of course, that no retractor pins are needed in the mold. Furthermore, an undimpled, smaller mold is used. If, however, a one piece ball is desired, a dimpled mold would be used.

If the component is a golf ball core layer, it typically contains 0 to 20 weight percent of filler material, and in specific embodiments 1 to 15 weight percent based on the weight of the layer.

If the component is an inner cover layer or mantle layer, it typically contains 0 to 60 weight percent of filler material; in other embodiments it contains 1 to 30 weight percent or 1 to 20 weight percent filler material based on the weight of the layer.

If the component is an outer cover layer, it typically contains 0 to 20 weight percent of filler material in other embodiments it contains 1 to 10 weight percent or 1 to 5 weight percent filler material based on the weight of the layer.

Fillers are used to adjust the density, flex modulus, mold release, and/or melt flow index of a layer. With some fillers, up to about 200 parts by weight can be used. When the filler is for adjustment of density or flex modulus of a layer, it is present in an amount of at least 5 parts by weight based upon 100 parts by weight of the layer.

A density adjusting filler is used to control the moment of inertia, and thus the initial spin rate of the ball and spin decay. The addition in one or more layers, and particularly in the outer cover layer, of a filler with a lower specific gravity than the resin composition results in a decrease in moment of inertia and a higher initial spin rate than would result if no filler were used. The addition in one or more of the cover layers, and particularly in the outer cover layer, of a filler with a higher specific gravity than the resin composition, results in an increase in moment of inertia and a lower initial spin rate. High specific gravity fillers are preferred as less volume is used to achieve the desired inner or outer cover total weight. Nonreinforcing fillers are also preferred as they have minimal effect on COR. Preferably, the filler does not chemically react with the resin composition to a substantial degree, although some reaction may occur when, for example, zinc oxide is used in a shell layer which contains some ionomer. The filler usually has a specific gravity which is at least 0.05, and in specific embodiments at least 0.1, higher or lower than the specific gravity of the layer composition. In further embodiments, density adjusting fillers are used which have specific gravities which are higher or lower than the specific gravity of the resin composition by 0.2 or more or by 2.0 or more.

A flex modulus adjusting filler is a filler which, e.g. when used in an amount of 1 to 100 parts by weight based upon 100 parts by weight of resin composition, will raise or lower the flex modulus (ASTM™ D-790) of the resin composition by at least 1% and preferably at least 5% as compared to the flex modulus of the resin composition without the inclusion of the flex modulus adjusting filler.

A mold release adjusting filler is a filler which allows for the easier removal of a part from a mold and eliminates or reduces the need for external release agents which otherwise could be applied to the mold. A mold release adjusting filler typically is used in an amount of up to about 2 weight percent based upon the total weight of the layer.

A melt flow index adjusting filler is a filler which increases or decreases the melt flow, or ease of processing, of the composition.

If the component is a layer, it may contain coupling agents that increase adhesion of materials within a particular layer, e.g. to couple a filler to a resin composition, or between adjacent layers. Non-limiting examples of coupling agents include titanates, zirconates and silanes. Coupling agents typically are used in amounts of 0.1 to 2 weight percent based upon the total weight of the composition in which the coupling agent is included.

Fillers which may be employed in layers other than the outer cover layer may be or are typically in a finely divided form, for example, in a size generally less than about 20 mesh, preferably less than about 100 mesh U.S. standard size, except for fibers and flock, which are generally elongated. Flock and fiber sizes should be small enough to facilitate processing. Filler particle size will depend upon desired effect, cost, ease of addition, and dusting considerations. The filler preferably is selected from the group consisting of precipitated hydrated silica, clay, talc, asbestos, glass fibers, aramid fibers, mica, calcium metasilicate, barium sulfate, zinc sulfide, lithopone, silicates, silicon carbide, diatomaceous earth, polyvinyl chloride, carbonates, metals, metal alloys, tungsten carbide, metal oxides, metal stearates, particulate carbonaceous materials, micro balloons, and combinations thereof.

In further embodiments, the materials and processes disclosed herein can be utilized to form other golf products and/or components thereof. For example, a face insert for a putter, iron or wood can be produced utilizing the technology set forth above.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes, modifications and substitutions of equivalents may be made therein without departing from the spirit and scope of this invention which is intended to be unlimited by the foregoing except as may appear in the following appended claims. Therefore, the embodiments of the invention in which an exclusive property or privilege is claimed are defined in the following appended claims.

We claim as our invention:

1. A method for making a golf ball component, comprising:
forming a fast-chemical-reaction mixture comprising an isocyanate prepolymer and a caprolactam polyol, the fast-chemical-reaction mixture formed in a reaction time of two minutes or less; and
molding the reaction mixture to form a golf ball component.

2. The method according to claim 1 wherein the reaction mixture further comprises a polyol or a chain extender.

3. The method according to claim 1 wherein the reaction mixture further comprises polypropylene glycol or polytetramethylene ether glycol.

4. The method according to claim 1 wherein the fast-chemical-reaction mixture is formed in a reaction time of one minute or less.

5. The method according to claim 1 wherein the fast-chemical-reaction mixture is formed in a reaction time of thirty seconds or less.

6. The method according to claim 1 wherein the component is selected from the group consisting of a one-piece golf ball, a cover, an intermediate layer, a layer of a cover, a core, and a layer of a core.
